(19) United States
(12) Patent Application Publication
(10) Pub. No.: US 2025/0252359 A1
(43) Pub. Date: Aug. 7, 2025

(54) MACHINE LEARNING DEVELOPMENT USING LANGUAGE MODELS

(71) Applicant: MICROSOFT TECHNOLOGY LICENSING, LLC, Redmond, WA (US)

(72) Inventors: Rohith Venkata PESALA, Snoqualmie, WA (US); Maurice DIESENDRUCK, Bellevue, WA (US); Hue Tuan THI, Redmond, WA (US); Gayathri MAHALINGAM, Bothell, WA (US); Ankur AGARWAL, Redmond, WA (US); Robin ABRAHAM, Redmond, WA (US)

(21) Appl. No.: 18/430,289

(22) Filed: Feb. 1, 2024

(51) Int. Cl. G06N 20/20

(52) U.S. Cl. CPC G06N 20/20

(57) ABSTRACT

Methods and apparatuses for providing a machine learning development platform that leverages a collection of reusable machine learning components and a natural language processing (NLP) assistant to reduce development time and reduce compute and data storage resources during the development and testing of machine learning programs are described. The NLP assistant may automatically configure, generate and test a pipeline of selected components from a collection of reusable machine learning components based on user instructions to the NLP assistant, component metadata that includes a natural language description for each component, and component interface information that includes input and output interface schemas for each component. The user instructions may comprise natural language instructions from text and/or audio transcriptions that specify a set of tasks to be performed by the pipeline of selected components.

### BACKGROUND

Recent years have seen the rapid growth in the capability and sophistication of artificial intelligence (AI) and machine learning (ML) software applications. For instance, transformer-based large language models (LLMs) have seen widespread adoption due to their diverse processing capabilities in vision, speech, language, and decision making. Unlike other AI models such as recurrent neural networks and long short-term memory (LSTM) models, transformer-based large language models make use of a native self-attention mechanism to identify vague context from limited available data and even synthesize new content from images and music to software. Commensurate with their capabilities, large language models are complex, oftentimes comprising millions if not billions of individual parameters. Accordingly, various organizations deploy large-scale computing infrastructure, such as cloud computing, to offer AI platforms tailored to enabling users to make use of cutting-edge large language models.

### BRIEF SUMMARY

Systems and methods are provided for reducing the time to develop machine learning programs and to extend the machine learning development process to many types of developers including beginners. As machine learning solutions are incorporated into an increasing number of applications, there is a growing need to make the machine learning development process less complex, more efficient, and more accessible to a wider range of developers. A machine learning development platform may leverage a collection of reusable machine learning components and a natural language processing (NLP) assistant to reduce development time and reduce compute and data storage resources during the development and testing of machine learning programs. The NLP assistant may automatically configure, generate and test a pipeline of selected components from a collection of reusable machine learning components based on user instructions to the NLP assistant, component metadata that includes a natural language description for each component, component interface information that includes input and output interface schemas for each component, and model performance metrics for each component such as run-time metrics and memory footprint requirements. The user instructions may comprise natural language instructions from text and/or audio inputs that specify a set of tasks to be performed by the pipeline of selected components.

According to some embodiments, the technical benefits of the systems and methods disclosed herein include reduced software development time, reduced cost of computing and storage resources during software development, and reduced power consumption of computing and storage resources during software development. Other technical benefits can also be realized through various implementations of the disclosed technologies.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1A depicts one embodiment of a machine learning development platform.

FIG. 1B depicts one embodiment of a machine learning development platform that utilizes a shareable component pool of machine learning components.

FIG. 1C depicts one embodiment of various machine learning component types and a template pipeline for generating a machine learning model corresponding with the component type for image classification.

FIG. 1D depicts one embodiment of an interaction between a natural language interface for a development copilot and a user for generating and executing a machine learning pipeline to generate and deploy a machine learning model for performing image classification.

FIG. 2A depicts one embodiment of a networked computing environment in which the disclosed technology may be practiced.

FIG. 2B depicts one embodiment of various components of a computing system for providing a machine learning development platform.

FIG. 3A depicts a flowchart describing one embodiment of a process for generating and deploying a machine learning model using a natural language processing (NLP) assistant.

FIG. 3B depicts a flowchart describing an alternative embodiment of a process for generating and deploying a machine learning model using an NLP assistant.

### DETAILED DESCRIPTION

The technologies described herein provide a machine learning development platform that leverages a collection of reusable machine learning components and an advanced natural language processing (NLP) assistant to reduce development time and extend the machine learning development process to many types of developers including beginners and subject matter experts (SMEs). The NLP assistant may automatically determine, generate, configure, and test a pipeline of selected components from the collection of reusable machine learning components based on user instructions to the NLP assistant. The pipeline (or model training pipeline) may correspond with a sequence of tasks and/or a sequence of machine learning components for training a machine learning model. The machine learning components may include components for performing data ingestion, data preprocessing, feature engineering, model training, and model validation. The machine learning development platform may provide the ability to select, train, test and deploy numerous machine learning models across a range of computing environments to support many different machine learning applications using the NLP assistant.

In some cases, an end user (or user) of the machine learning development platform provides user instructions that specify a set of tasks (e.g., for performing image classification or image segmentation) and the machine learning development platform may convert the user instructions into a ready-to-execute sequence of machine learning components. The sequence of machine learning components may correspond with a pipeline of selected components from the collection of reusable machine learning components that were selected by the NLP assistant. In one example, the user instructions correspond with generating a neural network for image classification and the NLP assistant may generate a pipeline of machine learning components for performing image classification.

The user instructions may comprise natural language instructions from text and/or audio inputs that specify the set of tasks to be performed by the pipeline of selected components. In one example, the user instructions correspond with one or more prompts that are provided to the NLP assistant using textual input. In another example, the user instructions correspond with one or more prompts that are provided to the NLP assistant using audio-derived input, such as an audio transcribed description of a pipeline of machine learning components.

The combination of the NLP assistant and the collection of reusable machine learning components (or machine learning development stages) may increase the efficiency of the machine learning development process by promoting reusability and consistency across machine learning components. Increasing the efficiency of the machine learning development process may reduce the number of machine learning components that need to be generated, stored, and tested when developing machine learning models, which leads to the technical benefits of reduced data storage requirements and reduced power consumption of hardware resources during machine learning model development. Moreover, utilizing the NLP assistant to configure and optimize a pipeline of machine learning components using a natural language interface also increases the efficiency of the machine learning development process, which leads to the technical benefits of reducing the number of compute and storage resources required to develop an application that utilizes machine learning models. Moreover, the number of people needed to develop, train, and test machine learning components may be significantly reduced.

Each machine learning development stage may comprise a set of machine learning components, models, and/or modules. The collection of machine learning development stages may be shared among numerous developers, allowing the developers to interact with the NLP assistant to access, reuse, and modify various components as needed for performing a set of tasks. As examples, the set of tasks may include classification and regression tasks.

A set of structured guidelines for standardizing the creation and modification of machine learning components may be used to ensure reusability of the machine learning components. The set of structured guidelines may require that each machine learning component adheres to a set of quality and interoperability criteria. Each machine learning component may be associated with component metadata that includes a descriptor for the component to facilitate efficient metadata-driven component retrieval and organization, as well as component interface information including input and output interface schemas. In one example, the descriptor for a component may comprise a natural language description from the component and the component may be defined to take in a set of images and output a machine learning model that performed image classification.

The machine learning development platform may merge development stages corresponding with data extract, transform, load (ETL) code, model development code, and model deployment code and may automatically generate and test various pipelines of machine learning components based on user instructions to the NLP assistant, component metadata that includes a natural language description for each component, component interface information that includes input and output interface schemas for each component, and model performance metrics for each component such as run-time metrics and memory footprint requirements.

In some cases, machine learning assets such as machine learning models and components may be stored in a registry or shared workspace that facilitates the sharing of machine learning models and pipelines. The shared workspace may comprise a centralized repository for storing and versioning machine learning models, pipelines, and artifacts. An artifact may refer to an output of a machine learning pipeline and may comprise a fully trained model, a model checkpoint (e.g., a snapshot of a model during a training process), or a file that is generated and stored during the training process. An artifact may comprise the output of data preprocessing functions or data extraction methods.

A machine learning workflow for developing machine learning models may include a number of phases including a data preparation phase, a training phase, and a deployment phase. The data preparation phase may include data ingestion, cleaning, validation, and transformation. The data preparation phase may include data labeling and data splitting steps for generating training and testing datasets to be used during the training phase. The quality of the training and testing datasets may have a large impact on the quality and performance of a resulting machine learning model. The training phase (or machine learning model generation phase) may include machine learning model training and hyperparameter tuning. The machine learning model generation phase includes the application of one or more machine learning algorithms to generate a machine learning model using the training and testing datasets. The process of applying machine learning algorithms to the training and testing datasets may include feature engineering and hyperparameter tuning (e.g., via cross-validation). The deployment phase may include integrating one or more machine learning models into an application and monitoring of the one or more machine learning models over time. In one example, a machine learning model may be deployed as a web service.

A development copilot may utilize a large language model (LLM) that has access to metadata (e.g., the machine learning component metadata) for components within the collection of reusable machine learning components to identify a pipeline of selected components based on input natural language instructions. The development copilot may then acquire program code corresponding with the pipeline of selected components and execute the program code to develop or generate a machine learning model. The development copilot may provide a chatbot interface to users providing the natural language instructions. The development copilot may leverage an NLP assistant to automatically configure, generate and execute a pipeline of selected components from a collection of reusable machine learning components based on user instructions to the NLP assistant. The development copilot may utilize a retrieval augmented generation system to identify the pipeline of selected components. Retrieval augmented generation (RAG) may refer to the process of optimizing a large language model (LLM) such that it references a knowledge base or external data outside of its training data sources to generate a response. Using RAG, the development copilot may first retrieve documents and information from a search system and then provide the retrieved documents and information to an LLM to generate an answer based on the retrieved documents and information. The answer may specify a pipeline of machine learning components.

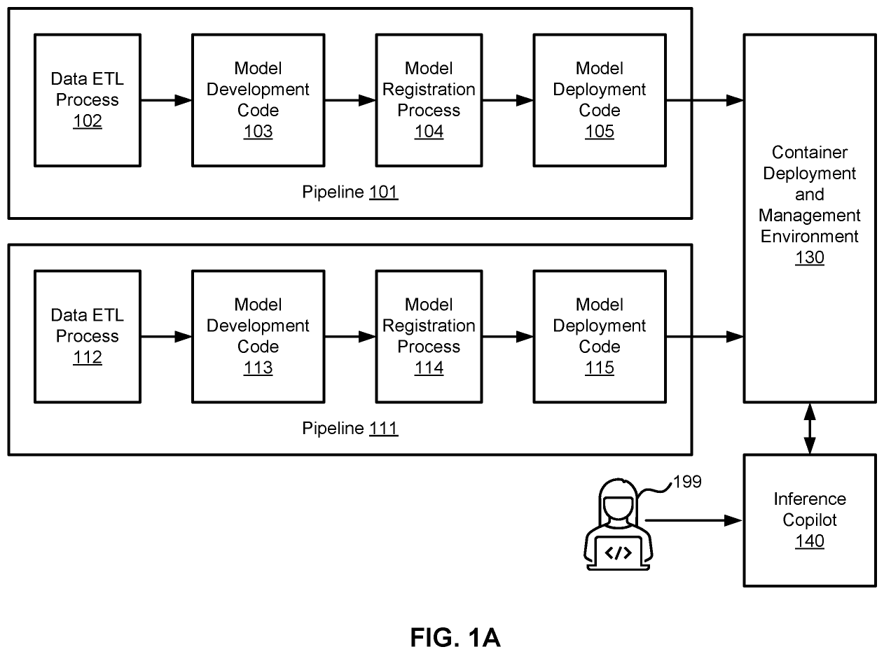

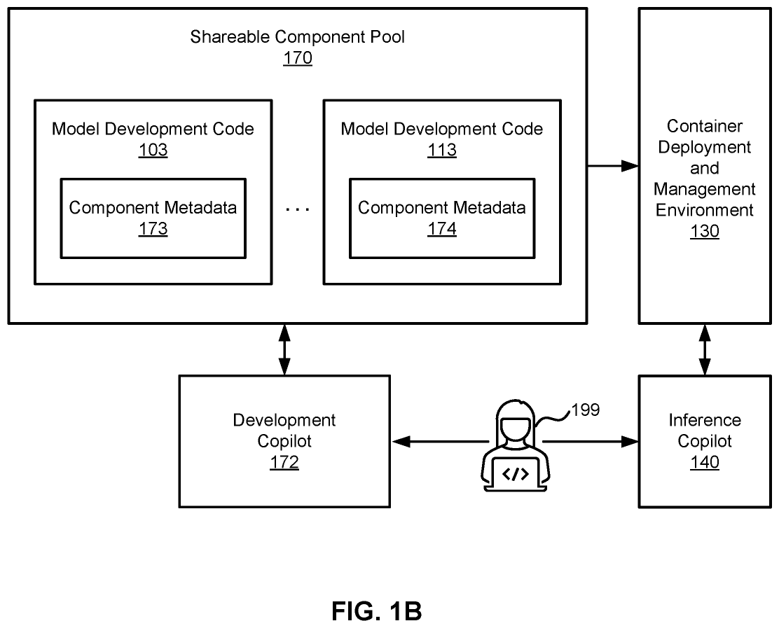

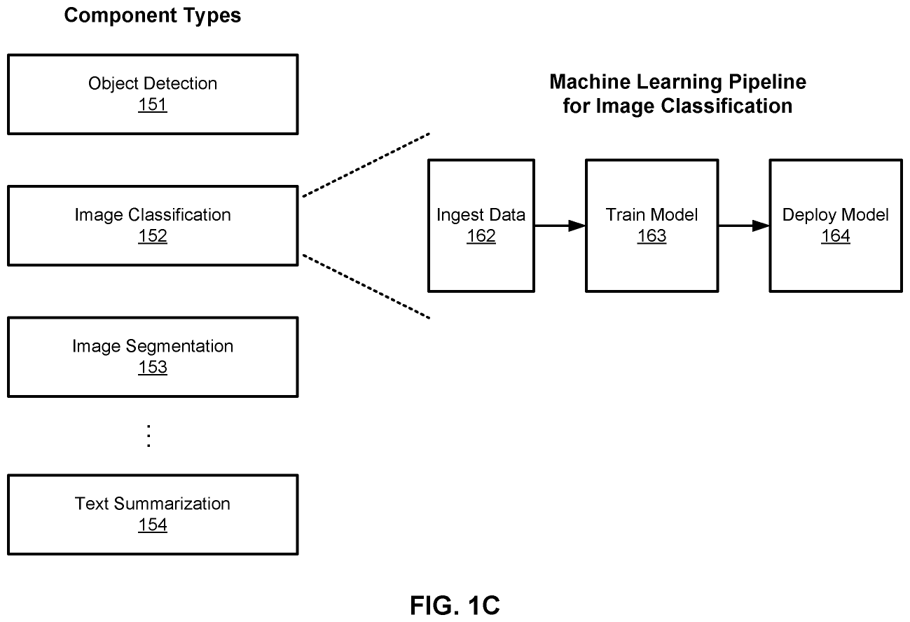

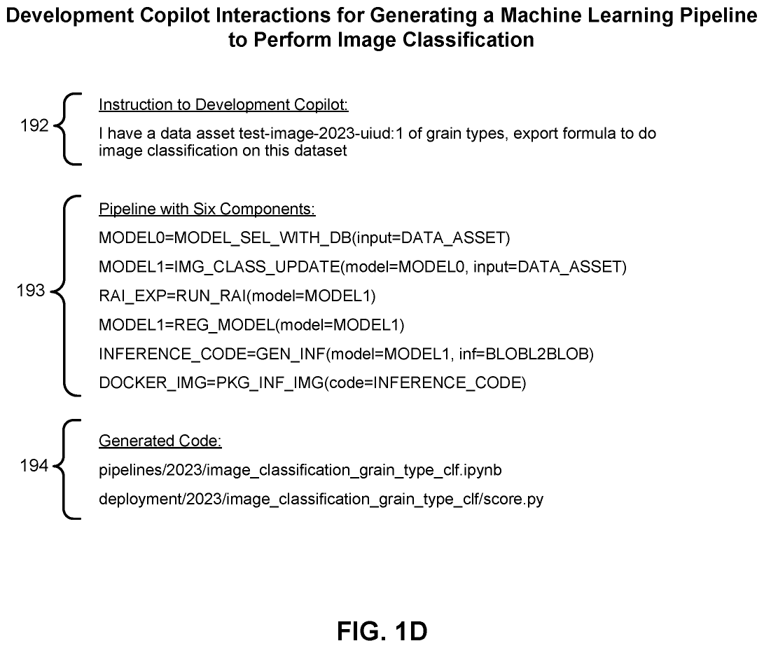

FIG. 1A depicts one embodiment of a machine learning development platform in which a user 199 interacts with an inference copilot 140 to manage and deploy machine learning pipelines within a container deployment and management environment 130. The data extract, transform, load (ETL) process 102, model development code 103, model registration process 104, and model deployment code 105 may correspond with a first machine learning pipeline 101. The data ETL process 112, model development code 113, model registration process 114, and model deployment code 115 may correspond with a second machine learning pipeline 111. The first machine learning pipeline 101 and the second machine learning pipeline 111 may be deployed using the container deployment and management environment 130. The pipeline components that contain executable code (e.g., the model deployment code) may be containerized prior to deployment. Containers may be used to package the machine learning models that are subsequently deployed using the container deployment and management environment 130, which may include a cloud computing infrastructure. In some cases, the container deployment and management environment 130 may include a model scoring service in which predictions are logged and stored to monitor a machine learning model's predictive performance.

In some cases, a pipeline, such as the first machine learning pipeline 101, may be evaluated using a task-specific evaluation metric such as mean absolute error (MAE) for regression tasks or area under curve (AUC) for binary classification tasks. The evaluation metric can be a mathematical calculation that results in numerical representation of machine learning performance for a specific task. Multiple machine learning pipelines may be evaluated and ranked by a machine learning workflow. Accordingly, a top-ranking machine learning pipeline having the greatest performance based on the evaluation metric may be selected as the best pipeline for performing the specific task. In this way, a user with minimal machine learning expertise can train and deploy machine learning models that are more accurate and effective than existing solutions (e.g., the use of heuristic algorithms).

The data ETL process 102 may be utilized to identify source data (e.g., training data) for generating a first machine learning model and to store the training data in a data store not depicted. In one example, the data ETL process 102 identifies source data based on user instructions that include a filename or a reference to the source data. The source data may be stored locally or accessed from a computer network. In another example, the data ETL process 102 identifies source data by searching a computer network (e.g., the Internet) and automatically downloading a dataset based on a particular link or data identifier for the source data.

The model development code 103 for the first machine learning model is selected based on a machine learning task specified by the user 199 via a user interface to the inference copilot 140. The inference copilot 140 may comprise an NLP assistant for handling natural language inputs from the user 199 and for selecting the model development code 103 based on the natural language inputs from the user 199. The first machine learning model corresponding with the model development code 103 may be registered with a machine learning component registry using model registration process 104. After registration, the model deployment code 105 associated with a version of the first machine learning model to be deployed may be wrapped in an inference image and stored in a container registry within the container deployment and management environment 130. After the model deployment code 105 has been deployed, the user 199 may interact with the inference copilot 140 to engage with the deployed version of the first machine learning model.

One issue with the machine learning development platform depicted in FIG. 1A is the repetition involved in developing machine learning components which may lead to both development and maintenance inefficiencies. Each new use case may result in a repetitive development cycle to generate a new machine learning model or pipeline. Moreover, as the number of use cases increases, maintaining a one-to-one relationship between each use case and its corresponding developer becomes increasingly challenging.

In some cases, a machine learning pipeline comprises a set of computational tasks for implementing a machine learning workflow. An end-to-end pipeline may include tasks for performing data preparation, model training, model deployment, and model monitoring. In one example, model training may be performed using model development code 103 and model deployment may be performed using model deployment code 105. A workspace may provide an environment for creating machine learning pipelines and provisioning and managing machine learning assets such as models and data. The workspace may manage data and model versions via a version control system to provide model reproducibility.

FIG. 1B depicts one embodiment of a machine learning development platform that utilizes a shareable component pool 170 of machine learning components. Each of the components within the shareable component pool 170 may adhere to specific guidelines covering input/output, documentation, testing, and versioning. Each of the components within the shareable component pool 170 may include component specific metadata. The metadata associated with a component may include attributes such as component name, program code for the component, and a natural language description for the component. Each natural language description for a component may be converted into an embedding vector that is indexed inside a database that may be accessed by a development copilot, such as the development copilot 172. The database may be deployed within a cloud computing environment.

The shareable component pool 170 may include numerous components. As depicted in FIG. 1B, the shareable component pool 170 includes the model development code 103 and the model development code 113. A user 199 may interact with an inference copilot 140 to manage and deploy machine learning pipelines within the container deployment and management environment 130 and may interact with a development copilot 172 to select and configure a machine learning pipeline comprising one or more components from the shareable component pool 170 of machine learning components. The development copilot 172 may translate natural language instructions from the user 199 and convert the instructions into a structured sequence of the machine learning components. The development copilot 172 may identify a machine learning pipeline to satisfy a machine learning task specified by the user 199. The development copilot 172 may utilize a Large Language Model (LLM) that has access to a set of in-context shareable components within the shareable component pool 170 to identity the best machine learning components to select for a machine learning pipeline based on instructions from the user 199 and metadata associated with the shareable components within the shareable component pool 170. In some cases, the development copilot 172 includes chatbot functionality that is deployed in a cloud-based web application.

The model development code 103 includes component metadata 173 and the model development code 113 includes component metadata 174. The model development code 103 for a first machine learning model may be reused with a plurality of machine learning pipelines. The component metadata 173 may include a natural language description for the first machine learning model. In one example, the natural language description may comprise “this component takes as input a training dataset and a validation dataset, it uses AutoML with defined models and hyperparameter spaces to build the best possible image classifier for the input dataset.” An automated machine learning process for developing machine learning models may be referred to as AutoML. The model development code 103 may also be associated with component interface information specifying inputs and outputs for the first machine learning model, as well as model performance metrics for the first machine learning model such as run-time metrics and memory footprint requirements for the first machine learning model.

FIG. 1C depicts one embodiment of various machine learning component types 151-154 and a template pipeline for generating a machine learning model corresponding with the component type for image classification 152. Each of the various machine learning component types 151-154 may map to a template pipeline for generating a machine learning model. The template pipeline corresponding with image classification 152 may be used to generate a machine learning model for predicting which class an input image belongs to (e.g., whether the input image includes a cat or a dog). The template pipeline corresponding with image classification 152 comprises machine learning components 162-164. The component 162 may perform data ingestion in which data is acquired from data sources, such as a database or cloud-based data storage, and preprocessed to generate data that is suitable for machine learning algorithms. The component 163 may perform model training in which preprocessed data is provided to a selected machine learning algorithm to train a machine learning model. The model training may include adjusting parameters of the machine learning model to minimize a predefined loss function. The component 164 may deploy the trained machine learning model within a computing environment, such as the container deployment and management environment 130 in FIG. 1B. The trained machine learning model may be deployed as a web service.

FIG. 1D depicts one embodiment of an interaction between a natural language interface for a development copilot, such as the development copilot 172 in FIG. 1B, and a user, such as user 199 in FIG. 1B, for generating and executing a machine learning pipeline to generate and deploy a machine learning model for performing image classification. In response to instructions from the user, the development copilot may identify and execute a pipeline for training a machine learning model and then deploy the trained machine learning model. As depicted, the user 199 has provided a prompt or instructions 192 to the development copilot via a text-based interface and in response the development copilot has identified and outputted a pipeline that includes six machine learning components 193 and has outputted corresponding code 194 for executing the machine learning components to train and deploy a machine learning model based on the instructions 192. In some cases, the six machine learning components 193 or a subset thereof are wrapped inside a code pipeline, which is used to generate and execute code to train a machine learning model and then deploy the machine learning model in a development environment, such as the container deployment and management environment 130 in FIG. 1B.

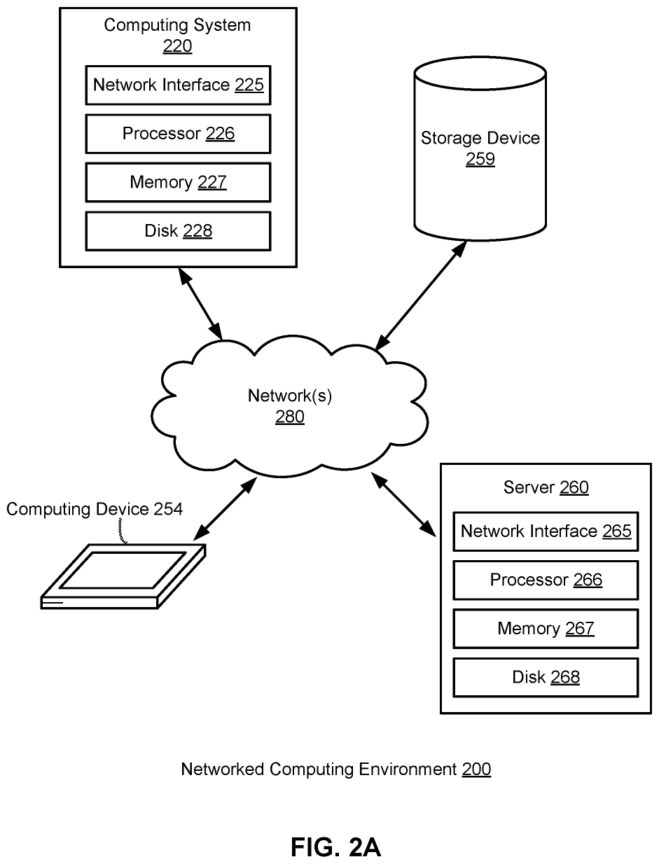

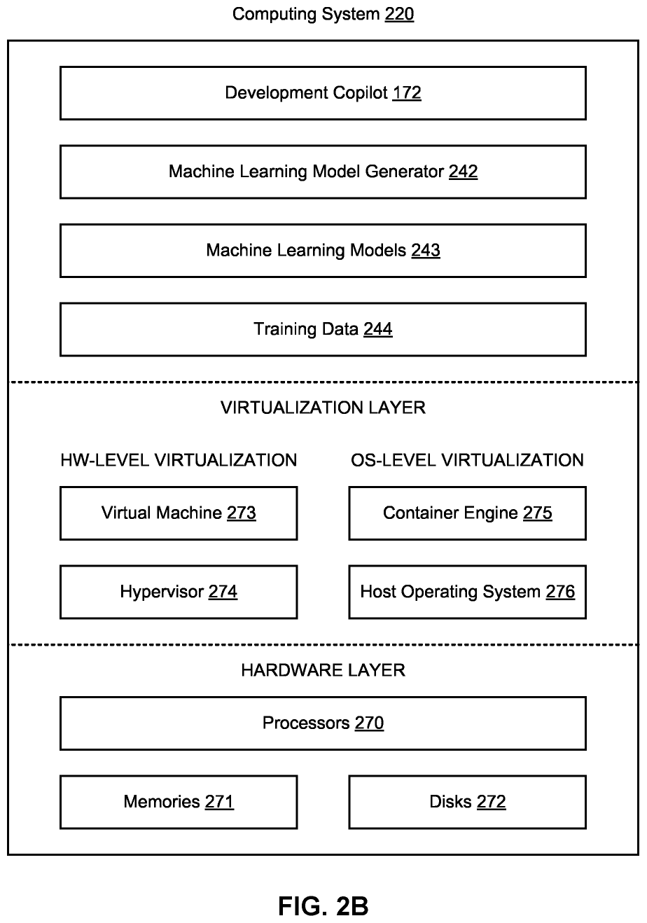

FIG. 2A depicts one embodiment of a networked computing environment 200 in which the disclosed technology may be practiced. The networked computing environment 200 includes a computing system 220, storage device 259, server 260, and a computing device 254 in communication with each other via one or more networks 280. The networked computing environment 200 may include various computing and storage devices interconnected through one or more networks 280. The networked computing environment 200 may correspond with or provide access to a cloud computing environment providing Software-as-a-Service (SaaS) or Infrastructure-as-a-Service (laaS) services. The one or more networks 280 may allow computing devices and/or storage devices to connect to and communicate with other computing devices and/or other storage devices. In some cases, the networked computing environment 200 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 280 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 200 comprises real hardware computing devices or virtual computing devices, such as one or more virtual machines. The storage devices within the networked computing environment 200 may comprise real hardware storage devices or virtual storage devices, such as one or more virtual disks. The real hardware storage devices may include non-volatile and volatile storage devices.

The computing system 220 may comprise a distributed computing system or a system for providing a cloud-based computing environment. As depicted in FIG. 2A, the computing system 220 includes a network interface 225, processor 226, memory 227, and disk 228 all in communication with each other. The network interface 225, processor 226, memory 227, and disk 228 may comprise real components or virtualized components. In some cases, the network interface 225, processor 226, memory 227, and disk 228 may be provided by a virtualized infrastructure or a cloud-based infrastructure. Network interface 225 allows the computing system 220 to connect to one or more networks 280. Network interface 225 may include a wireless network interface and/or a wired network interface. Processor 226 allows the computing system 220 to execute computer readable instructions stored in memory 227 in order to perform processes described herein. Processor 226 may include one or more processing units, such as one or more CPUs, one or more GPUs, and/or one or more NPUs. Memory 227 may comprise one or more types of memory (e.g., RAM, SRAM, DRAM, EEPROM, Flash). Disk 228 may include a hard disk drive and/or a solid-state drive. Memory 227 and disk 228 may comprise hardware storage devices.

The computing device 254 may comprise a mobile computing device, such as a tablet computer, that allows a user to access a graphical user interface for the computing system 220. A user interface may be provided by the computing system 220 and displayed using a display screen of the computing device 254.

A server, such as server 260, may allow a client device, such as the computing system 220 or computing device 254, to download information or files (e.g., executable, text, application, audio, image, or video files) from the server. The server 260 may comprise a hardware server. In some cases, the server may act as an application server or a file server. In general, a server may refer to a hardware device that acts as the host in a client-server relationship or to a software process that shares a resource with or performs work for one or more clients. The server 260 may store or provide access to a database.

The server 260 includes a network interface 265, processor 266, memory 267, and disk 268 all in communication with each other. Network interface 265 allows server 260 to connect to one or more networks 280. Network interface 265 may include a wireless network interface and/or a wired network interface. Processor 266 allows server 260 to execute computer readable instructions stored in memory 267 in order to perform processes described herein. Processor 266 may include one or more processing units, such as one or more CPUs, one or more GPUs, and/or one or more NPUs. Memory 267 may comprise one or more types of memory (e.g., RAM, SRAM, DRAM, EEPROM, Flash). Disk 268 may include a hard disk drive and/or a solid-state drive. In some cases, the disk 268 includes a flash-based SSD or a hybrid HDD/SSD drive. Memory 267 and disk 268 may comprise hardware storage devices.

The networked computing environment 200 may provide a cloud computing environment for one or more computing devices. In one embodiment, the networked computing environment 200 may include a virtualized infrastructure that provides software, data processing, and/or data storage services to end users accessing the services via the networked computing environment. In one example, networked computing environment 200 may provide cloud-based applications to computing devices, such as computing device 254, using the computing system 220, storage device 259, and/or server 260.

FIG. 2B depicts one embodiment of various components of the computing system 220 in FIG. 2A. As depicted, the computing system 220 includes hardware-level components and software-level components. The hardware-level components may include one or more processors 270, one or more memories 271, and one or more disks 272. The one or more processors 270 may include one or more processing units, such as one or more CPUs, one or more GPUs, and/or one or more NPUs. The one or more memories 271 may comprise one or more types of memory (e.g., RAM, SRAM, DRAM, EEPROM, Flash). The one or more disks 228 may include a hard disk drive and/or a solid-state drive. Both the one or more memories 271 and the one or more disks 272 may comprise hardware storage devices.

The software-level components may include software applications and computer programs. The development copilot 172, machine learning model generator 242, and machine learning models 243, and training data 244 may be stored or implemented using software or a combination of hardware and software. In some cases, the software-level components are run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

As depicted in FIG. 2B, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications. The virtual machine 273 may run the host operation system 276 upon which the container engine 275 may run.

The container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

In some embodiments, the depicted components of the computing system 220 including the development copilot 172 are implemented in the cloud or in a virtualized environment that allows virtual hardware to be created and decoupled from the underlying physical hardware. The machine learning models 243 may comprise one or more machine learning models that are stored in a memory, such as one or more memories 271. The one or more machine learning models may be trained, executed, and/or deployed using one or more processors, such as the one or more processors 270.

The one or more machine learning models may include neural networks (e.g., deep neural networks), support vector machine models, decision tree-based models, k-nearest neighbor models, Bayesian networks, or other types of models such as linear models and/or non-linear models. A linear model may be specified as a linear combination of input features. A neural network may comprise a feed-forward neural network, recurrent neural network, or a convolutional neural network. The one or more machine learning models may include one or more generative AI models. The one or more machine learning models may include one or more multimodal models. The one or more machine learning models may include one or more large language models.

In some cases, the computing system 220 utilizes the machine learning model generator 242, machine learning models 243, and training data 244 to implement various machine learning algorithms, such as supervised machine learning algorithms. Supervised machine learning refers to machine learning methods where labeled training data is used to train or generate a machine learning model or set of mapping functions that maps input feature vectors to output predicted answers. The trained machine learning model may be deployed to map new input feature vectors to predicted answers. Supervised machine learning can be used to solve regression and classification problems. A regression problem is where the output predicted answer comprises a numerical value. Regression algorithms include linear regression, polynomial regression, and logistic regression algorithms. A classification problem is where the output predicted answer comprises a label (or an identification of a particular class). Classification algorithms include support vector machine, decision tree, k-nearest neighbor, and random forest algorithms.

In some cases, a support vector machine algorithm determines a hyperplane (or decision boundary) that maximizes the distance between data points for two different classes. The hyperplane separates the data points for the two different classes and a margin between the hyperplane and a set of nearest data points (or support vectors) is determined to maximize the distance between the data points for the two different classes.

In some cases, a k-nearest neighbor algorithm determines a set of test data points and a set of training data points, identifies a distance function, calculates distances between a selected data point of the set of test data points to each of the set of training data points using the distance function, and then sorts the calculated distances to identify a subset of the set of training data points that are closest to the selected data point (e.g., the k-nearest neighbors to the selected data point). The distance function calculates a Euclidean distance, a Manhattan distance, or a Hamming distance. In at least one example, the k-nearest neighbor algorithm comprises an approximate k-nearest neighbor algorithm that utilizes navigable small world graphs with controllable hierarchy.

During a training phase, a machine learning model, such as one of the machine learning models 243, is trained to generate predicted answers using a set of labeled training data, such as training data 244. The training data 244 is stored in a memory, such as one or more memories 271. In some cases, labeled data is split into a training data set and an evaluation data set prior to or during the training phase. The machine learning model generator 242 may implement a machine learning algorithm that uses a training data set from the training data 244 to train the machine learning model and uses the evaluation data set to evaluate the predictive ability of the trained machine learning model. The predictive performance of the trained machine learning model is determined by comparing predicted answers generated by the trained machine learning model with the target answers in the evaluation data set (or ground truth values). For a linear model, the machine learning algorithm determines a weight for each input feature to generate a trained machine learning model that can output a predicted answer. In some cases, the machine learning algorithm includes a loss function and an optimization technique. The loss function is used to quantify the penalty that is incurred when a predicted answer generated by the machine learning model does not equal the appropriate target answer. The optimization technique seeks to minimize the quantified loss. One example of an appropriate optimization technique is online stochastic gradient descent.

In some embodiments, the machine learning model generator 242 trains a machine learning model using one or more training or learning algorithms. In one example, the machine learning model generator 242 utilizes backwards propagation of errors (or backpropagation) to train a multi-layer neural network. In some cases, the machine learning model generator 242 performs supervised training techniques using a set of labeled training data. In other cases, the machine learning model generator 242 performs unsupervised training techniques using a set of unlabeled training data. The machine learning model generator 242 may also perform a number of generalization techniques to improve the generalization capability of the machine learning models being trained, such as weight-decay and dropout regularization.

In some embodiments, the training data 244 includes a set of training examples. In at least one example, each training example of the set of training examples includes an input-output pair, such as a pair comprising an input vector and a target answer (or supervisory signal). In another example, each training example of the set of training examples includes an input vector and a pair of outcomes corresponding with a first decision to perform a first action and a second decision to not perform the first action. In this case, each outcome of the pair of outcomes is scored and a positive label is applied to the higher scoring outcome while a negative label is applied to the lower scoring outcome.

A large language model (LLM) may refer to a language model that comprises a neural network with a large number of parameters (e.g., millions or billions of parameters or weights). In order to reduce training time and cost, transfer learning may be utilized in which a pre-trained model is used as a starting point for a specific task and then trained or fine-tuned with a supervised dataset for the specific task. In one example, an LLM may be pre-trained using a large dataset and then fine-tuned using a much smaller dataset to tailor the LLM to solve a specific task. Pretraining may refer to the act of training a machine learning model from scratch without any prior knowledge using a large corpus of data. Fine-tuning may refer to a transfer learning process that modifies a pretrained LLM by training the LLM in a supervised or semi-supervised manner. In some cases, the fine-tuning involves adapting a pretrained LLM for a specific task by fine-tuning the LLM using a task specific dataset.

An LLM may comprise a transformer model that is implemented using a transformer-based neural network architecture. A transformer model may include an encoder and/or a decoder. An encoder may extract features from an input sequence and a decoder may use the extracted features from the encoder to produce an output sequence. In some cases, an encoder comprises one or more encoding layers and a decoder may comprise one or more decoding layers. Each encoding and decoding layer may include a self-attention mechanism that relates tokens within a sequence of tokens to other tokens within the sequence. In one example, the self-attention mechanism may allow the transformer model to examine a word within a sentence and determine the relative importance of other words within the same sentence to the examined word. In some cases, an encoder includes a self-attention layer and a feed forward neural network layer and a decoder may include two self-attention layers and a feed forward neural network layer. A transformer model (or transformer) may utilize an encoder-decoder architecture, an encoder only architecture, or a decoder only architecture.

One example of a transformer model is a Generative Pre-trained Transformer (GPT) model. A GPT model may comprise a type of LLM that uses deep learning to generate human-like text. A GPT model may be referred to as being “generative” because it can generate new content based on a given input prompt (e.g., a text prompt), “pre-trained” because it is trained on a large corpus of data before being fine-tuned for specific tasks, and a “transformer” because it utilizes a transformer-based neural network architecture to process the input prompt to generate the output content (or response). Generative AI may be used to generate new content, such as text, images, audio, and video content.

In some embodiments, a machine learning model is trained to generate a language text response (or completion) given an inputted text prompt. The inputted text prompt may provide information to help guide the machine learning model to generate an appropriate text response. Prompt engineering may be used to alter or update the inputted text prompt such that the machine learning model generates a more relevant text response. In some cases, the text response is generated by predicting the next set of words in a sequence of words provided by the inputted text prompt using a transformer model, such as a GPT language model. The transformer model may be trained using sets of input prompt-response pairs.

Multimodal learning may refer to a type of machine learning in which a machine learning model is trained to understand multiple forms of input data (e.g., text, images, video, and audio data) that derive from different modalities. A multimodal model may comprise a model whose inputs and/or outputs include more than one modality. For example, a multimodal model may take both an image and a text caption as input features, and output a score indicating how appropriate the text caption is for the image. Image data may include different types of images, such as color images, depth images, and thermal images. In some cases, a machine learning model comprises a multimodal model, a language model, or a visual model.

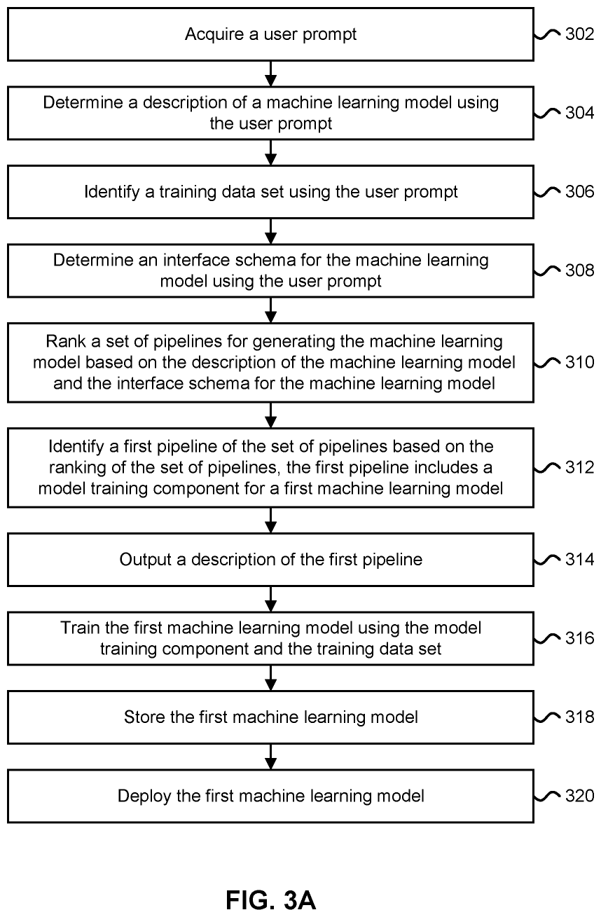

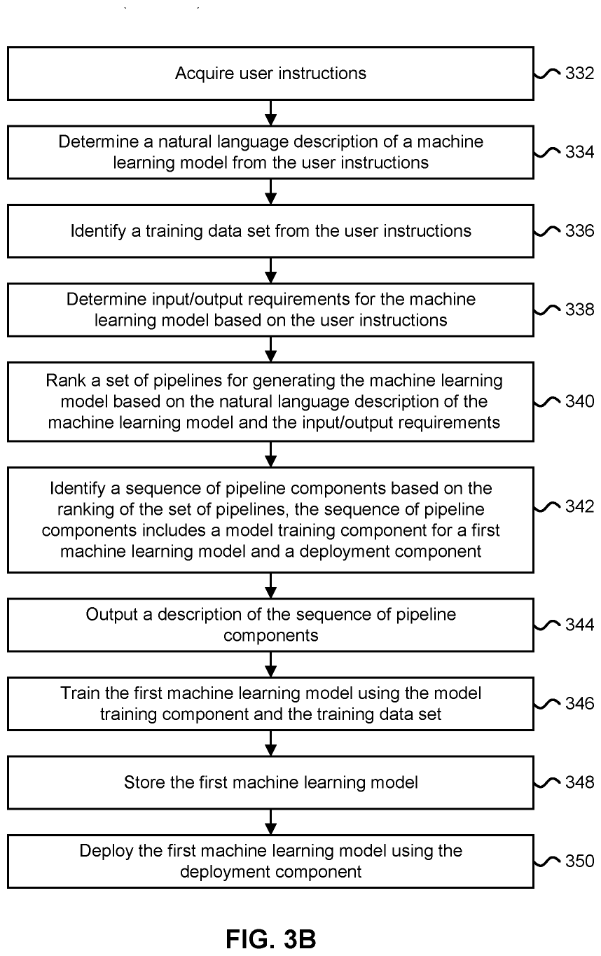

FIG. 3A depicts a flowchart describing one embodiment of a process for generating and deploying a machine learning model using a natural language processing (NLP) assistant. In one embodiment, the process of FIG. 3A may be performed by a computing system, such as the computing system 220 in FIG. 2B. In another embodiment, the process of FIG. 3A may be implemented using a cloud-based computing platform or cloud-based computing services.

In step 302, a user prompt is acquired. The user prompt may correspond with the instructions 192 in FIG. 1D. In step 304, a description of a machine learning model is determined using the user prompt. In one example, a description of the machine learning model is determined using a generative model to generate a natural language description for the machine learning model using the user prompt. In step 306, a training data set is identified using the user prompt. In step 308, an interface schema for the machine learning model is determined using the user prompt. The interface schema may correspond to a required input and output for the machine learning model. In step 310, a set of pipelines for generating the machine learning model is ranked based on the description of the machine learning model and the interface schema for the machine learning model.

In one embodiment, the set of pipelines may correspond to different component types, such as component types 151-154 in FIG. 1C, and the description of the machine learning model may be used to identify a closest matching component type from the set of component types. In another embodiment, each pipeline of the set of pipelines may correspond to a natural language description for the generation of a machine learning model for the pipeline and the input-output requirements for the machine learning model. A score may be generated for each pipeline of the set of pipelines based on the similarity between the description of the machine learning model derived from the user prompt and the natural language description of a machine learning model for the pipeline. The score may also take into consideration the similarity between the interface schema for the machine learning model derived from the user prompt and the input-output requirements for the machine learning model for the pipeline. In some cases, as LLMs have the ability to understand code directly, a score may be generated for each pipeline of the set of pipelines based on the similarity between the description of the machine learning model derived from the user prompt and code associated with a machine learning model for the pipeline.

In step 312, a first pipeline of the set of pipelines is identified based on the ranking of the set of pipelines. The first pipeline includes a model training component for a first machine learning model. The first pipeline may comprise the highest scoring pipeline out of the set of pipelines. The first pipeline may comprise the pipeline out of the set of pipelines with the most similar description of the machine learning model and the most similar interface schema for the machine learning model. In step 314, a description of the first pipeline is outputted. In one example, the description of the first pipeline corresponds with the six machine learning components 193 in FIG. 1D.

In step 316, the first machine learning model is trained using the model training component identified in step 312 and the training data set. In step 318, the first machine learning model is stored. The first machine learning model may be stored as one of the machine learning models 243 in FIG. 2B. In step 320, the first machine learning model is deployed. The first machine learning model may be deployed using a container deployment and management environment, such as the container deployment and management environment 130 in FIG. 1B.

FIG. 3B depicts a flowchart describing an alternative embodiment of a process for generating and deploying a machine learning model using an NLP assistant. In one embodiment, the process of FIG. 3B may be performed by a computing system, such as the computing system 220 in FIG. 2B. In another embodiment, the process of FIG. 3B may be implemented using a cloud-based computing platform or cloud-based computing services.

In step 332, user instructions are acquired. The user instructions may be acquired at a development copilot, such as the development copilot 172 in FIG. 1B. The user instructions may comprise text-based user instructions. In step 334, a natural language description of a machine learning model is determined from the user instructions. In step 336, a training data set is identified from the user instructions. Both the natural language description and the training data set may be specified within the user instructions or derived from a natural language description included within the user instructions. In step 338, input/output requirements are determined for the machine learning model based on the user instructions. In one example, it may be required that the machine learning model takes as input an image and outputs a label or classification for the image.

In step 340, each pipeline of a set of pipelines for generating the machine learning model is ranked based on the natural language description of the machine learning model and the input/output requirements for the machine learning model. In step 342, a sequence of pipeline components is identified based on the ranking of the set of pipelines. The sequence of pipeline components includes a model training component for a first machine learning model and a deployment component. The sequence of pipeline components may also include a preprocessing component, a database management component, a storage management component, and an evaluation of benchmarks component.

In some embodiments, the sequence of pipeline components is identified based on the natural language description of the machine learning model. The sequence of pipeline components including the model training component for the first machine learning model and the deployment component for the first machine learning model may be identified without ranking a set of pre-defined pipelines. The sequence of pipeline components may be identified as the most suitable pipeline components given the natural language description of the machine learning model within the context of a set of pre-defined pipelines. In this case, the sequence of pipeline components identified may or may not directly correspond to one of the pre-defined pipelines out of the set of pre-defined pipelines. The set of pre-defined pipelines may correspond to the template pipelines associated with the machine learning component types 151-154 depicted in FIG. 1C.

In step 344, a description of the sequence of pipeline components is outputted. In one example, the description of the sequence of pipeline components corresponds with the six machine learning components 193 in FIG. 1D. In step 346, the first machine learning model is trained using the model training component and the training data set. In step 348, the first machine learning model is stored. In step 350, the first machine learning model is deployed using the deployment component. In one example, the model training component corresponds to the component 163 in FIG. 1C, the deployment component corresponds to the component 164 in FIG. 1C, and the first machine learning model corresponds to a machine learning model for performing image classification.

At least one embodiment of the disclosed technology includes a storage device for storing instructions that, when executed, cause a system to perform operations comprising acquiring user instructions; determining a natural language description of a machine learning model from the user instructions; identifying a training data set from the user instructions; identifying a sequence of pipeline components based on the natural language description of the machine learning model, the sequence of pipeline components includes a model training component for a first machine learning model and a deployment component for the first machine learning model; training the first machine learning model using the model training component and the training data set; and deploying the first machine learning model using the deployment component.

In some cases, further comprising instructions that, when executed, cause the system to perform operations comprising determining model performance metrics for the machine learning model based on the user instructions; ranking a set of pipelines for generating the machine learning model based on the natural language description of the machine learning model; and identifying the sequence of pipeline components based on the ranking of the set of pipelines. The sequence of pipeline components may include the model training component for the first machine learning model, the deployment component for the first machine learning model, a preprocessing component, a database management component, a storage management component, and an evaluation of benchmarks component.

At least one embodiment of the disclosed technology includes a storage device for storing instructions that, when executed, cause a system to perform operations comprising acquiring user instructions; determining a natural language description of a machine learning model from the user instructions; identifying a training data set from the user instructions; ranking a set of pipelines for generating the machine learning model based on the natural language description of the machine learning model; identifying a sequence of pipeline components based on the ranking of the set of pipelines, the sequence of pipeline components includes a model training component for a first machine learning model and a deployment component for the first machine learning model; training the first machine learning model using the model training component and the training data set; and deploying the first machine learning model using the deployment component.

In some cases, further comprising instructions that, when executed, cause the system to perform operations comprising determining model performance metrics for the machine learning model based on the user instructions. The ranking the set of pipelines may include ranking the set of pipelines based on the model performance metrics for the machine learning model. The model performance metrics for the machine learning model may include a memory footprint metric (e.g., a memory size) for the machine learning model and/or a run-time metric (e.g., an estimated run time for generating an output) for the machine learning model.

At least one embodiment of the disclosed technology includes acquiring user instructions; determining a natural language description of a machine learning model from the user instructions; identifying a training data set from the user instructions; identifying a sequence of pipeline components based on the natural language description of the machine learning model, the sequence of pipeline components includes a model training component for a first machine learning model and a deployment component for the first machine learning model; training the first machine learning model using the model training component and the training data set; and deploying the first machine learning model using the deployment component.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The invention claimed is:

1. A system for providing a machine learning development platform, comprising:
a storage device for storing instructions that, when executed, cause the system to perform operations comprising:
acquiring user instructions;
determining a natural language description of a machine learning model from the user instructions;
identifying a training data set from the user instructions;
identifying a sequence of pipeline components based on the natural language description of the machine learning model, the sequence of pipeline components includes a model training component for a first machine learning model and a deployment component for the first machine learning model;
training the first machine learning model using the model training component and the training data set; and
deploying the first machine learning model using the deployment component.

2. The system of claim 1, further comprising instructions that, when executed, cause the system to perform operations comprising:
determining model performance metrics for the machine learning model based on the user instructions;
ranking a set of pipelines for generating the machine learning model based on the natural language description of the machine learning model; and
identifying the sequence of pipeline components based on the ranking of the set of pipelines, the sequence of pipeline components includes the model training component for the first machine learning model, the deployment component for the first machine learning model, a preprocessing component, a database management component, a storage management component, and an evaluation of benchmarks component.

3. The system of claim 2, wherein:
the ranking the set of pipelines includes ranking the set of pipelines based on the model performance metrics for the machine learning model.

4. The system of claim 3, wherein:
the model performance metrics for the machine learning model include a memory footprint metric for the machine learning model.

5. The system of claim 3, wherein:
the model performance metrics for the machine learning model include a run-time metric for the machine learning model.

6. The system of claim 2, further comprising instructions that, when executed, cause the system to perform operations comprising:
determining input and output requirements for the machine learning model based on the user instructions.

7. The system of claim 6, wherein:
the ranking the set of pipelines includes ranking the set of pipelines based on the input and output requirements for the machine learning model.

8. The system of claim 2, further comprising instructions that, when executed, cause the system to perform operations comprising:
storing the first machine learning model, the ranking the set of pipelines includes ranking the set of pipelines based on the natural language description of the machine learning and code associated with the first machine learning model.

9. The system of claim 2, wherein:
the ranking the set of pipelines includes generating a similarity score between the natural language description for the machine learning model and a natural language description for the first machine learning model associated with the sequence of pipeline components.

10. The system of claim 1, wherein:
the user instructions are derived from an audio description of a machine learning pipeline for performing image classification.

11. A method for operating a machine learning development platform, comprising:
acquiring user instructions;
determining a natural language description of a machine learning model from the user instructions;
identifying a training data set from the user instructions;
identifying a sequence of pipeline components based on the natural language description of the machine learning model, the sequence of pipeline components includes a model training component for a first machine learning model and a deployment component for the first machine learning model;
training the first machine learning model using the model training component and the training data set; and
deploying the first machine learning model using the deployment component.

12. The method of claim 11, further comprising:
ranking a set of pipelines for generating the machine learning model based on the natural language description of the machine learning model; and
identifying the sequence of pipeline components based on the ranking of the set of pipelines.

13. The method of claim 12, further comprising:
ranking the set of pipelines for generating the machine learning model based on model performance metrics for the machine learning model.

14. The method of claim 13, wherein:
the model performance metrics for the machine learning model include a memory size for the machine learning model.

15. The method of claim 11, further comprising:
determining an input and output interface schema for the machine learning model based on the user instructions; and
identifying the sequence of pipeline components based on the input and output interface schema for the machine learning model.

16. The method of claim 11, wherein:
the identifying the sequence of pipeline components includes identifying the sequence of pipeline components based on a first similarity score between the natural language description for the machine learning model and a natural language description for the first machine learning model associated with the sequence of pipeline components or based on a second similarity score between the natural language description for the machine learning model and a natural language description for the first machine learning model associated with the sequence of pipeline components.

17. The method of claim 11, wherein:
the identifying the sequence of pipeline components includes identifying the sequence of pipeline components based on a similarity score between an input and output interface schema for the machine learning model and input and output requirements for the first machine learning model.

18. The method of claim 11, wherein:
the user instructions are derived from a text-based description of the machine learning model.

19. The method of claim 11, wherein:
the user instructions are derived from an audio description of a machine learning pipeline for performing image classification.

20. A system, comprising:
a storage device configured to store a first machine learning model; and
a processing system in communication with the storage device that is configured to:
acquire a user prompt;
determine a description of a machine learning model using the user prompt;
identify a training data set using the user prompt;
determine an interface schema for the machine learning model using the user prompt;
rank a set of pipelines for generating the machine learning model based on the description of the machine learning model and the interface schema for the machine learning model;
identify a first pipeline of the set of pipelines based on the ranking of the set of pipelines, the first pipeline includes a model training component for the first machine learning model and a deployment component for the first machine learning model;
train the first machine learning model using the model training component and the training data set; and
deploy the first machine learning model using the deployment component.
